(19) United States
(12) Patent Application Publication
(10) Pub. No.: US 2024/0362486 A1
(43) Pub. Date: Oct. 31, 2024

(54) MODEL TRAINING METHOD AND APPARATUS, AND READABLE STORAGE MEDIUM

(71) Applicant: Beijing Zitiao Network Technology Co., Ltd., Beijing (CN)

(72) Inventor: Haien ZENG, Beijing (CN)

(21) Appl. No.: 18/565,920

(22) PCT Filed: May 9, 2022
(86) PCT No.: PCT/CN2022/091675

§ 371 Date: Nov. 30, 2023

(30) Foreign Application Priority Data
Jun. 23, 2021 (CN) 202110700060.4

(51) Int. Cl. G06N 3/082

(52) U.S. Cl. CPC G06N 3/082

(57) ABSTRACT

A model training method includes: acquiring a sample data set corresponding to a target task, a teacher model and an ith initial student model; performing an ith time of channel pruning on the ith initial student model, to acquire a student model subjected to the ith time of channel pruning; performing knowledge distillation according to the sample data set, the teacher model and the student model subjected to the ith time of channel pruning, to acquire an (i+1)th initial student model, wherein a compression ratio of the (i+1)th initial student model to the ith initial student model is equal to a preset ith compression ratio; and updating i to be i+1, and returning to the step of performing the ith time of channel pruning on the ith initial student model, until the updated i is greater than a threshold value N, to acquire a target student model.

### CROSS-REFERENCE TO RELATED APPLICATION

This application claims priority to Chinese Patent Application No. 202110700060.4, filed on Jun. 23, 2021, and titled “MODEL TRAINING METHOD AND APPARATUS, AND READABLE STORAGE MEDIUM”, the entire contents of which are herein incorporated by reference.

### FIELD

The present disclosure relates to the technical field of computer processing, and in particular, to a method, an apparatus, and a readable storage medium for model training.

### BACKGROUND

The application of deep neural networks in various tasks is increasing, and the more complex the tasks is, the greater the scales of the deep neural networks are, and the greater the consumption of computing resources brought by the deep neural networks is. Therefore, the model compression technology is also receiving more and more attention under actual demands.

Knowledge distillation is one of the important methods for compressing deep neural network models. Specifically, a large-scale model is pre-trained to serve as a teacher model, then a small-scale model is selected as a student model, the output of the teacher model is learned by the student model to obtain a trained student model, the trained student model is close to the teacher model in performance, but is less than the teacher model in scale. However, the trained student model obtained by knowledge distillation has worse performance.

### SUMMARY

In order to solve the above technical problems or at least partially solve the above technical problems, the present disclosure provides a method, an apparatus, and a readable storage medium for model training.

In a first aspect, an embodiment of the present disclosure provides a method for model training, including:
step (a): acquiring a sample data set, a teacher model and an ith initial student model, which correspond to a target task, wherein the teacher model is a model trained for the target task;
step (b): performing an ith time of channel pruning on the ith initial student model, so as to acquire a student model which has been subjected to the ith time of channel pruning, wherein an initial value of i is 1;
step (c): according to the sample data set and the teacher mode, performing an ith time of knowledge distillation training on the student model which has been subjected to the ith time of channel pruning, so as to acquire an (i+1)th initial student model, wherein a compression ratio of the (i+1)th initial student model to a first initial student model is equal to a preset ith compression ratio; and
updating i to be i+1, and returning to the step (a) to the step (c) until the updated i is greater than a preset threshold value N, so as to acquire a target student model, wherein the target student model is an (N+1)th initial student model, and N is an integer greater than or equal to 1.

In some possible designs, when i=1, the ith initial student model and the teacher model are models with the same network structure.

In some possible designs, the preset ith compression ratio is jointly determined according to the scale of the target student model, the scale of the first initial student model, and the preset threshold value N.

In some possible designs, the preset ith compression ratio is jointly determined according to the scale of the target student model, the scale of the first initial student model and the preset threshold value N, and the determining includes:
determining a target compression ratio according to the scale of the target student model and the scale of the first initial student model;
determining a target compression sub-ratio according to the target compression ratio and the preset threshold value N; and
using an ith multiple of the target compression sub-ratio as the preset ith compression ratio.

In some possible designs, performing the ith time of channel pruning on the ith initial student model, so as to acquire the student model which has been subjected to the ith time of channel pruning, includes:
acquiring importance factors of channels in a target layer of the ith initial student model; and
sequentially deleting M channels in the target layer according to the sequence of the importance factors from low to high, so as to acquire the student model which has been subjected to the ith time of channel pruning, wherein M is a positive integer greater than or equal to 1, and M is less than the total number of channels of the ith initial student model.

In some possible designs, according to the sample data set and the teacher mode, performing knowledge distillation training on the student model which has been subjected to the ith time of channel pruning, so as to acquire the (i+1)th initial student model, includes:
respectively inputting sample data in the sample data set into the teacher model and the student model which has been subjected to the ith time of channel pruning, so as to acquire a first result output by the teacher model and a second result output by the student model which has been subjected to the ith time of channel pruning;
acquiring first loss information according to the first result output by the teacher model, the second result output by the student model which has been subjected to the ith time of channel pruning, and a truth value annotation of the sample data; and
according to the first loss information, adjusting a weight coefficient of a target parameter in the student model which has been subjected to the ith time of channel pruning, so as to acquire the (i+1)th initial student model.

In some possible designs, acquiring the first loss information according to the first result output by the teacher model, the second result output by the student model which has been subjected to the ith time of channel pruning, and the truth value annotation of the sample data, includes:
acquiring second loss information according to the first result output by the teacher model and the second result output by the student model which has been subjected to the ith time of channel pruning;
acquiring third loss information according to the second result output by the student model which has been subjected to the ith time of channel pruning and the truth value annotation of the sample data; and
acquiring the first loss information according to the second loss information and the third loss information.

In a second aspect, an embodiment of the present disclosure provides an apparatus for model training, including:
an acquisition module, configured to execute step (a): acquiring a sample data set, a teacher model and an ith initial student model, which correspond to a target task, wherein the teacher model is a model trained for the target task;
a channel pruning module, configured to execute step (b): performing an ith time of channel pruning on the ith initial student model, so as to acquire a student model which has been subjected to the ith time of channel pruning, wherein an initial value of i is 1;
a knowledge distillation module, configured to execute step (c): performing an ith time of knowledge distillation according to the sample data set, the teacher model and the student model which has been subjected to the ith time of channel pruning, so as to acquire an (i+1)th initial student model, wherein a compression ratio of the (i+1)th initial student model to a first initial student model is equal to a preset ith compression ratio; and
an update module, configured to update i to be i+1, causing the channel pruning module to execute the step (a) and causing the knowledge distillation module to execute the step (c) until the updated i is greater than a preset threshold value N, so as to acquire a target student model, wherein the target student model is an (N+1)th initial student model, and N is an integer greater than or equal to 1.

In some possible designs, when i=1, the ith initial student model and the teacher model are models with the same network structure.

In some possible designs, the preset ith compression ratio is jointly determined according to the scale of the target student model, the scale of the first initial student model, and the preset threshold value N.

In some possible designs, the preset ith compression ratio is jointly determined according to the scale of the target student model, the scale of the first initial student model and the preset threshold value N, and the determining includes: determining a target compression ratio according to the scale of the target student model and the scale of the first initial student model; determining a target compression sub-ratio according to the target compression ratio and the preset threshold value N; and using an ith multiple of the target compression sub-ratio as the preset ith compression ratio.

In some possible designs, the channel pruning module is specifically configured to: acquire importance factors of channels in a target layer of the ith initial student model; and sequentially delete M channels in the target layer according to the sequence of the importance factors from low to high, so as to acquire the student model which has been subjected to the ith time of channel pruning, wherein M is a positive integer greater than or equal to 1, and M is less than the total number of channels of the ith initial student model.

In some possible designs, the knowledge distillation module is specifically configured to: respectively input sample data in the sample data set into the teacher model and the student model which has been subjected to the ith time of channel pruning, so as to acquire a first result output by the teacher model and a second result output by the student model which has been subjected to the ith time of channel pruning; acquire first loss information according to the first result output by the teacher model, the second result output by the student model which has been subjected to the ith time of channel pruning, and a truth value annotation of the sample data; and according to the first loss information, adjust a weight coefficient of a target parameter in the student model which has been subjected to the ith time of channel pruning, so as to acquire the (i+1)th initial student model.

In some possible designs, the knowledge distillation module is specifically configured to: acquire second loss information according to the first result output by the teacher model and the second result output by the student model which has been subjected to the ith time of channel pruning; acquire third loss information according to the second result output by the student model which has been subjected to the ith time of channel pruning, and the truth value annotation of the sample data; and acquire the first loss information according to the second loss information and the third loss information.

In a third aspect, an embodiment of the present disclosure further provides an electronic device, including: a memory, a processor and a computer program instruction;
the memory is configured to store the computer program instruction; and
the processor is configured to execute the computer program instruction, so as to implement the method according to any item of the first aspect.

In a fourth aspect, an embodiment of the present disclosure further provides a readable storage medium, including: a computer program, wherein when executed by at least one processor of an electronic device, the computer program implements the method according to any item of the first aspect.

In a fifth aspect, an embodiment of the present disclosure further provides a program product, wherein the program product includes a computer program, the computer program is stored in a readable storage medium, at least one processor of an apparatus for model training may read the computer program from the readable storage medium, and the at least one processor executes the computer program to implement the method according to any item of the first aspect.

The embodiments of the present disclosure provide a method, an apparatus, and a readable storage medium for model training. The method includes the following steps: (a) acquiring a sample data set, a teacher model and an ith initial student model, which correspond to a target task; (b) performing an ith time of channel pruning on the ith initial student model, so as to acquire a student model which has been subjected to the ith time of channel pruning, wherein an initial value of i is 1; (c): performing knowledge distillation training according to the sample data set, the teacher mode and the student model which has been subjected to the ith time of channel pruning, so as to acquire an (i+1)th initial student model, wherein a compression ratio of the (i+1)th initial student model to the ith initial student model is equal to a preset ith compression ratio; and updating i to be i+1, and returning to the step (a) to the step (c) until the updated i is greater than a preset threshold value N, so as to acquire a target student model. In the present solution, step-by-step compression is realized by means of successive pruning iterations, and the training effect and convergence of the target student model are ensured by knowledge distillation, thereby improving the performance of the target student model.

### BRIEF DESCRIPTION OF THE DRAWINGS

The drawings are incorporated in and constitute a part of the present specification, illustrate embodiments conforming to the present disclosure, and serve to explain, together with the specification, the principles of the present disclosure.

To illustrate technical solutions in the embodiments of the present disclosure or in the prior art more clearly, a brief introduction on the drawings which are needed in the description of the embodiments or the prior art is given below. Apparently, other drawings may be obtained by those ordinary skilled in the art according to these drawings without any creative effort.

FIG. 1 is a flowchart of a method for model training provided in an embodiment of the present disclosure;

FIG. 2 is a flowchart of a method for model training provided in another embodiment of the present disclosure;

FIG. 3 is a flowchart of knowledge distillation training provided in the present disclosure;

FIG. 4 is a schematic structural diagram of an apparatus for model training provided in an embodiment of the present disclosure; and

FIG. 5 is a schematic structural diagram of an electronic device provided in another embodiment of the present disclosure.

### DETAILED DESCRIPTION OF EMBODIMENTS

In order to more clearly understand the above objectives, features and advantages of the present disclosure, the solutions of the present disclosure will be further described below. It should be noted that, in the case of no conflict, the embodiments of the present disclosure and the features in the embodiments may be combined with each other.

Numerous specific details are set forth in the following description to facilitate a thorough understanding of the present disclosure, but the present disclosure may also be implemented in other different manners than that described herein; and obviously, the embodiments in the specification are only a part, but not all, of the embodiments of the present disclosure.

Channel pruning and knowledge distillation are two hot spot technologies of the current model compression, an obtained compressed model has worse performance if channel pruning is used alone, or if knowledge distillation is used alone.

In order to solve this problem, the present disclosure provides a method for model training, and the core of the method is to combine channel pruning with knowledge distillation in an iterative update manner, so as to realize step-by-step compression and successive iteration. The scale of a model is reduced by channel pruning in each round of iterative update, and a weight coefficient is adjusted for a pruned model obtained by each channel pruning operation; specifically, knowledge distillation is introduced into an adjustment process in the present disclosure, and the pruned model can learn more information from a teacher model by means of knowledge distillation, thereby obtaining a better training result and convergence.

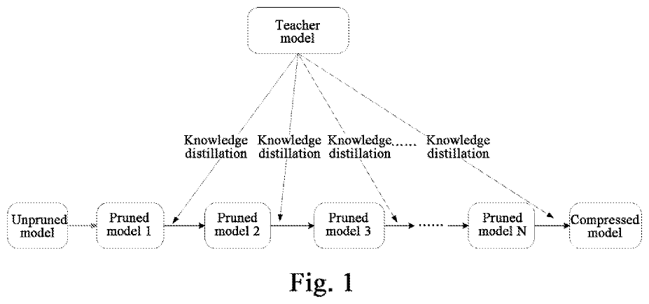

FIG. 1 illustrates a flowchart of a method for model training provided in an embodiment of the present disclosure. As shown in FIG. 1, firstly, channel pruning is performed on an unpruned original model, so as to obtain a pruned model 1; then, a weight coefficient of the pruned model 1 is adjusted, and knowledge distillation is introduced in the process to obtain a model which has been subjected to first-time iterative update; channel pruning is performed on the model which has been subjected to first-time iterative update, so as to obtain a pruned model 2; then, the weight coefficient of the pruned model 2 is adjusted, and knowledge distillation is introduced in the process to obtain a model which has been subjected to second-time iterative update; channel pruning is performed on the model which has been subjected to second-time iterative update, so as to obtain a pruned model 3; then, the weight coefficient of the pruned model 3 is adjusted, and knowledge distillation is introduced in the process to obtain a model which has been subjected to third-time iterative update; and so on, until the number of iterations reaches N to obtain a compressed model.

Compared with a manner in which a model is compressed to a target size by using channel pruning alone, or compared with a manner of performing model compression by using knowledge distillation alone, the present solution ensures that the obtained compressed model has better performance by combining channel pruning with knowledge distillation.

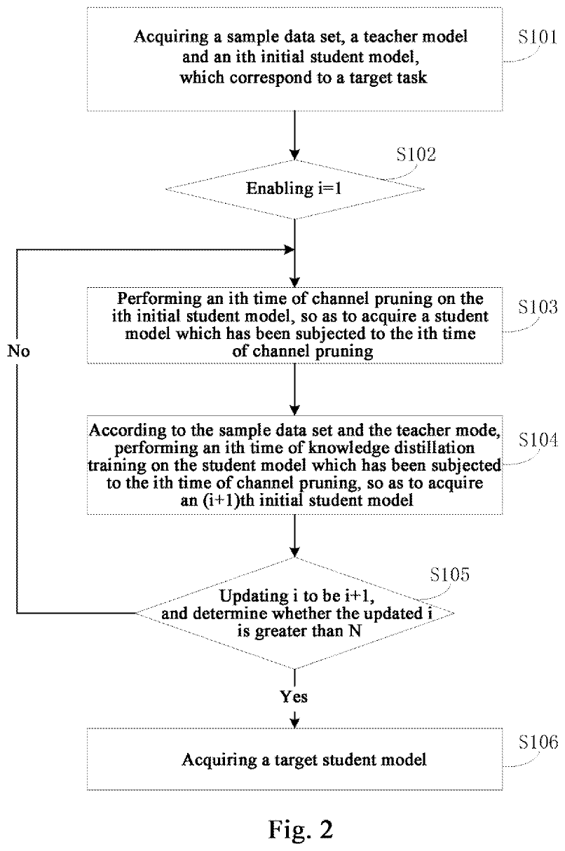

FIG. 2 is a flowchart of a method for model training provided in an embodiment of the present disclosure. The executive body of the method for model training provided in the present embodiment may be an apparatus for model training provided in an embodiment of the present disclosure, and the apparatus for model training may be implemented by any software and/or hardware, for example, the apparatus for model training may include, but is not limited to, an electronic device such as a notebook computer, a desktop computer, a server, a server cluster, and the like. In the present embodiment, it is taken as an example for illustration that the implementation body is the apparatus for model training. Referring to FIG. 2, the method in the present embodiment includes:

S101: acquiring a sample data set, a teacher model and an ith initial student model, which correspond to a target task.

The teacher model is a model trained for the target task. The teacher model may also be referred to as a pre-trained teacher model, a teacher model, a first model, or other names. The teacher model may be pre-trained and stored in the apparatus for model training, and may also be obtained by the apparatus for model training by means of training an initial teacher model via the above sample data set.

The ith initial student model may be a model trained for the target task, and may also be an untrained student model. The ith initial student model may also be referred to as a student model, a model to be compressed, or other names. If the ith initial student model is an untrained student model, a weight coefficient of each parameter included in the ith initial student model may be determined by random initialization, and may also be preset.

Optionally, when i=1, the teacher model and the first initial student model are models with the same network structure. When the teacher model and the first initial student model are models with the same network structure, the teacher model and/or the first initial student model may be prevented from being obtained by additional training, thereby reducing the consumption of computing resources.

S102, enabling i=1, that is, an initial value of i is 1.

S103: performing an ith time of channel pruning on the ith initial student model, so as to acquire a student model which has been subjected to the ith time of channel pruning.

In a possible implementation, importance factors corresponding to channels in a target layer of the ith initial student model may be acquired at first; the importance factors corresponding to the channels in the target layer are sorted; M channels are deleted according to the sequence of the importance factors from low to high, so as to obtain the student model which has been subjected to the ith time of channel pruning, wherein M is a positive integer greater than or equal to 1, and M is less than the total number of channels of the ith initial student model.

Assuming that the target layer is an output layer, and the target layer of the ith initial student model has 32 channels, then M may be equal to an integer multiple of 8.

In another possible implementation, the pruning position (i.e., the target layer) and the pruning number corresponding to the ith time of channel pruning may be determined according to a preset channel pruning mode. For example, the preset channel pruning mode may include: performing cyclic channel pruning layer by layer according to a preset sequence; or, pruning specific layers in sequence according to a preset sequence; or, performing channel pruning on one or more layers in a random manner, wherein the number of deleted channels may be random or preset.

Optionally, the importance factors of the channels in the target layer of the ith initial student model may be obtained according to the weight coefficients of the parameters of the corresponding channels.

Exemplarily, the importance factor may be denoted as Eᵣ^{l}, wherein r represents an index of each channel in the layer l; and l represents an index of the target layer.

In a possible implementation, the importance factor Eᵣ^{l} satisfies formula (1):

$${E}_{r}^{l} = {\sum }_{j} {( {W}_{rj}^{l} )}^{2} , r = 1 , 2 … {C}^{l} ; \qquad Formula ( 1 )$$

wherein, C^{l} represents the total number of the channels of the layer l; W represents the weight coefficient; and Wᵣⱼ^{l} represents a jth weight coefficient of a rth channel of the layer l.

S104: according to the sample data set and the teacher mode, performing an ith time of knowledge distillation training on the student model which has been subjected to the ith time of channel pruning, so as to acquire an (i+1)th initial student model.

A compression ratio of the (i+1)th initial student model to a first initial student model is equal to a preset ith compression ratio.

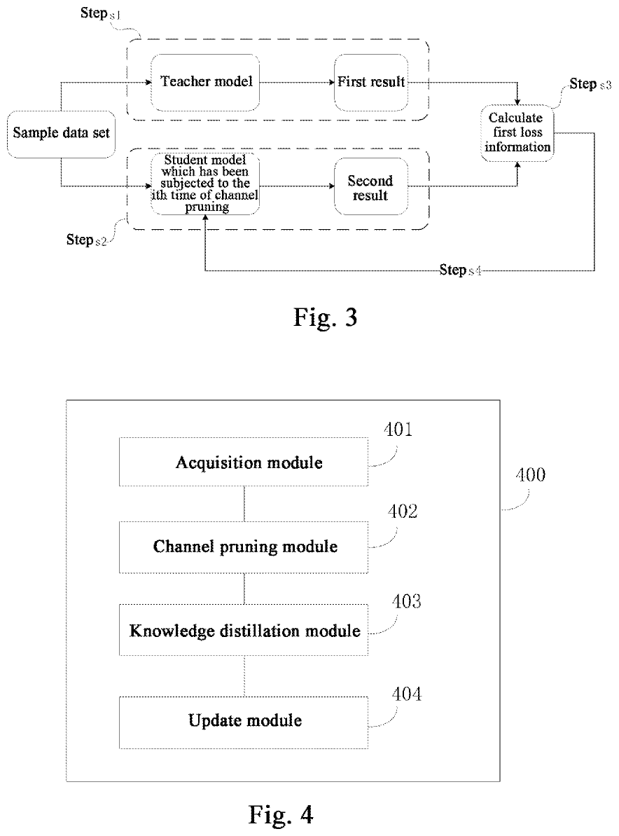

Exemplarily, FIG. 3 illustrates a flowchart of performing the ith time of knowledge distillation training on the student model which has been subjected to the ith time of channel pruning.

Referring to FIG. 3, the knowledge distillation training may include the following steps:
Step s1: inputting each piece of sample data in the sample data set into the teacher model, so as to acquire a first result which is output by the teacher model and respectively corresponds to each piece of sample data.
Step s2: inputting each piece of sample data in the sample data set into the student model which has been subjected to the ith time of channel pruning, and training the student model which has been subjected to the ith time of channel pruning, so as to acquire a second result which respectively corresponds to each piece of sample data and is output by the student model which has been subjected to the ith time of channel pruning.
Step s3: according to the first result respectively corresponding to each piece of sample data, the second result respectively corresponding to each piece of sample data, and a truth value annotation respectively carried in each piece of sample data, performing calculation to obtain first loss information corresponding to the student model which has been subjected to the ith time of channel pruning.

In the present solution, the first loss information may be obtained according to second loss information and third loss information. The first loss information may be denoted as Lossₜₒₜₐₗ₍ᵢ₎, the second loss information may be denoted as Loss_{distill(i)}, and the third loss information may be denoted as Loss_{gt(i)}. The second loss information is a knowledge distillation loss, and the second loss information may be calculated according to the first result and the second result; and the third loss information is an original loss of the student model which has been subjected to the ith time of channel pruning, or, may also be understood as the original loss of the student model during the ith time of knowledge distillation training.

Exemplarily, the first loss information corresponding to the student model which has been subjected to the ith time of channel pruning may satisfy formula (2):

$${Loss}_{total ( i )} = {λ}_{1 ( i )} * {Loss}_{distill ( i )} + {λ}_{2 ( i )} * {Loss}_{gt ( i )} \qquad Formula ( 2 )$$

wherein, λ₁₍ᵢ₎ represents the weight coefficient of the second loss information Loss_{distill(i)}; and λ₂₍ᵢ₎ represents represents the weight coefficient of the third loss information Loss_{gt(i)}.

Optionally, λ₂₍ᵢ₎ may be equal to a constant, for example, λ₂₍ᵢ₎ is equal to constant 1. Moreover, during the knowledge distillation training process, the proportion of the second loss information and the third loss information may be adjusted by adjusting the value of λ₁.
Step s4: according to the first loss information, adjusting the weight coefficient of a target parameter included in the student model which has been subjected to the ith time of channel pruning, so as to obtain a candidate student model.

If the candidate student model obtained in the step s4 satisfies a model convergence condition corresponding to the present knowledge distillation training, it is determined that the candidate student model obtained in the step s4 is the (i+1)th initial student model; and if the candidate student model obtained in the step s4 does not satisfy the model convergence condition corresponding to the present knowledge distillation training, the step s1 to the step s4 are executed until the model convergence condition corresponding to the present knowledge distillation training is satisfied, so as to obtain the (i+1)th initial student model. The (i+1)th initial student model is an initial student model for performing an (i+1)th time of channel pruning.

It should be noted that the process of repeatedly executing the step s1 to the step s4 to obtain the (i+1)th initial student model according to the student model which has been subjected to the ith time of channel pruning may be regarded as a round of or once knowledge distillation training.

Assuming that i is equal to 1, the step s1 to the step s4 are repeatedly executed to obtain a second initial student model. Moreover, in the present solution, after the channel pruning in S102 and the knowledge distillation training in S103, a compression ratio of the obtained second initial student model to the first initial student model is equal to a preset first compression ratio. The compression ratio of the second initial student model to the first initial student model may be a ratio of the calculated amount of the second initial student model to the calculated amount of the first initial student model. The calculated amount of the second initial student model may be determined according to a function included in each layer in the second initial student model; and the calculated amount of the first initial student model may be determined according to a function included in each layer in the first initial student model.

S105: updating i to be i+1, and determining whether the updated i is greater than a preset threshold value N, wherein N is an integer greater than or equal to 1.

The preset threshold value N represents a preset number of iterations, and the preset number of iterations may also be understood as a preset model convergence condition.

If the updated i is less than or equal to the preset threshold value N, S103 to S105 are executed again; and if the updated i is greater than the preset threshold value N, S106 is executed.

S106: acquiring a target student model.

Specifically, if the updated i is less than or equal to the preset threshold value N, it indicates that the current number of iterations does not reach the preset number of iterations, and the preset model convergence condition is not satisfied, therefore the next round of iterative update needs to be performed, and thus S103 to S105 are executed again.

If the updated i is greater than the preset threshold value N, it indicates that the current number of iterations reaches the preset number of iterations, and the preset model convergence condition is satisfied, therefore the apparatus for model training may store the network structure of the (i+1)th initial student model obtained in the last time of knowledge distillation training and the weight coefficients of the corresponding parameters, and the (i+1)th initial student model obtained in the last time of knowledge distillation training is the target student model. That is, in the present solution, N rounds of iterative update need to be performed, each round of iterative update includes once includes once channel pruning and once knowledge distillation training, that is, N times of channel pruning and N times of knowledge distillation training need to performed in the N rounds of iterative update, and the model obtained in the last round of iterative update is the target student model.

In the present solution, the target layers respectively corresponding to the N times of channel pruning may be different. For example, each of the first initial student model to an Nth initial student model include S intermediate layers, and cyclic channel pruning may be performed according to the sequence from a first intermediate layer to an Sth intermediate layer; or, channel pruning may also be performed on specific intermediate layers according to a preset sequence; or, channel pruning may also be performed on one or more intermediate layers in a random manner, and the pruning number corresponding to each time of channel pruning may be random or preset. S is an integer greater than or equal to 1.

Exemplarily, it is assumed that each of the first initial student model to the Nth initial student model includes three intermediate layers, and when the channel pruning is performed according to the sequence from the first intermediate layer to the Sth intermediate layer: when first-time channel pruning is performed, channel pruning is performed on the first intermediate layer of the first initial student model, and the pruning number is M₁; when second-time channel pruning is performed, channel pruning is performed on a second intermediate layer of a second initial student model, and the pruning number is M₂; when third-time channel pruning is performed, channel pruning is performed on a third intermediate layer of a third initial student model, and the pruning number is M₃; when fourth-time channel pruning is performed, channel pruning is performed on the first intermediate layer of a fourth initial student model, and the pruning number is M₄; and so on. The pruning number corresponding to each time of channel pruning may be the same or may not be completely the same.

Exemplarily, it is assumed that each of the first initial student model to the Nth initial student model includes three intermediate layers, and when the channel pruning is performed on the specific layers according to the preset sequence: when first-time channel pruning is performed, channel pruning is performed on the first intermediate layer of the first initial student model, and the pruning number is M₁; when second-time channel pruning is performed, channel pruning is performed on the third intermediate layer of the second initial student model, and the pruning number is M₂; when third-time channel pruning is performed, channel pruning is performed on the first intermediate layer of the third initial student model, and the pruning number is M₃; when fourth-time channel pruning is performed, channel pruning is performed on the third intermediate layer of the fourth initial student model, and the pruning number is M₄; and so on. The pruning number corresponding to each time of channel pruning may be the same or may not be completely the same.

The case where the N times of channel pruning respectively correspond to different target layers are exemplarily introduced above, but are not intended to limit the specific implementations of different target layers respectively corresponding to the N times of channel pruning. In addition, for each time of channel pruning, reference may be made to the implementation manner in S103, and thus for the sake of brevity, details are not described herein again.

In the present solution, when the first initial student model and the teacher model are models with the same network structure, the model compression is mainly implemented by channel pruning. The compression ratio corresponding to each time of channel pruning is a compression ratio corresponding to each round of iterative update. It should be noted that, in the present solution, the compression ratio corresponding to each round of iterative update is a ratio of the scale of the student model output in the current round of iterative update to the scale of the first initial student model.

Specifically, the compression ratio corresponding to each round of iterative update may be determined by any one of the following manners:

In a possible implementation, the compression ratio corresponding to each round of iterative update may be determined according to the scale of the target student model, the scale of the first initial student model and the preset threshold value N. Specifically, the following steps may be included:
Step w1: determining the scale of the target student model, and obtaining a target compression ratio according to the scale of the target student model and the scale of the first initial student model.

The scale of the target student model may be determined according to a model compression requirement. For example, in the target task, the waiting duration of the user is set to be 1 second, but the time consumed by the current model for executing the target task is 2 seconds, then the model compression requirement is 0.5 multiples, that is, the model is compressed into one half of the original model.

The target compression ratio satisfies formula (3):

$$PR = \frac{size ( T )}{size ( {T}_{1} )} \qquad Formula ( 3 )$$

In formula (3), PR represents the target compression ratio; size (T₁) represents the scale of the first initial student model T₁; and size(T) represents the scale of the target student model T.
Step w2: obtaining a target compression sub-ratio according to the target compression ratio and the preset threshold value N, wherein the target compression sub-ratio is an increase amplitude of the compression ratio corresponding to each round of iterative update.

For the step w2, in a possible implementation, and the increase amplitudes of the compression ratios of any two adjacent rounds of iterative update are the same. In this case, the increase amplitudes of the compression ratios of any two adjacent rounds of iterative update satisfy formula (4):

$$step = \frac{size ( T )}{size ( {T}_{1} )} \times \frac{1}{N} \qquad Formula ( 4 )$$

In formula (4), step represents the increase amplitudes of the compression ratios of any two adjacent rounds of iterative update.

Referring to formula (4), it can be seen that the compression ratio corresponding to the ith round of iterative update satisfies formula (5):

$${PR}_{i} = i ( \frac{size ( T )}{size ( {T}_{1} )} \times \frac{1}{N} ) \qquad Formula ( 5 )$$

In formula (5), PRᵢ represents the compression ratio of the ith round of iterative update, that is, an ith compression ratio; and size(Tᵢ₊₁) represents the scale of the (i+1)th initial student model.

For step w2, in another possible implementation, the increase amplitudes of the compression ratios of any two adjacent rounds of iterative update are not completely the same. In this case, the increase amplitude of the compression ratio corresponding to each round of iterative update may be preset, which satisfies the condition that the target student model obtained after the N rounds of iterative update meets the model compression requirement.

In the present solution, in the process of N times of knowledge distillation training, during each time of knowledge distillation training, the weight coefficient corresponding to the second loss information may be the same or different; and similarly, during each time of knowledge distillation training, the weight coefficient corresponding to the third loss information may be the same or different.

Exemplarily, during the first-time knowledge distillation, λ₁₍₁₎=0.5, and λ₂₍₁₎=1; and during the second-time knowledge distillation, λλ₁₍₁₎₌1, and λ₂₍₁₎=1.

In actual applications, the proportion of the second loss information and the third loss information may be adjusted by adjusting the weight coefficient corresponding to the second loss information and the weight coefficient corresponding to the third loss information, thereby improving the model convergence speed.

It should be understood that the knowledge distillation training can enable the student model which has been subjected to channel pruning to learn more information or knowledge, the knowledge distillation can train the weight coefficient of the pruned student model, but cannot change the scale of the pruned student model.

According to the method for model training provided in the present embodiment, the sample data set, the teacher model and the ith initial student model, which corresponds to the target task, are acquired; the ith time of channel pruning is performed on the ith initial student model, so as to acquire the student model which has been subjected to the ith time of channel pruning, wherein the initial value of i is 1; according to the sample data set and the teacher mode, knowledge distillation training is performed on the student model which has been subjected to the ith time of channel pruning, so as to acquire the (i+1)th initial student model, wherein the compression ratio of the (i+1)th initial student model to the ith initial student model is equal to the preset ith compression ratio; and i is updated to be i+1, and the ith time of channel pruning and the knowledge distillation training are performed on the ith initial student model again until the updated i is greater than the preset threshold value N, so as to acquire the target student model, wherein the target student model is the (N+1)th initial student model, and N is an integer greater than or equal to 1. In the present solution, step-by-step compression is realized by means of successive channel pruning iterations; and the knowledge distillation training is introduced after each time of channel pruning iteration, so that the student model which has been subjected to channel pruning can learn more information, thereby ensuring a better training result and convergence, and improving the performance of the target student model.

FIG. 4 is a schematic structural diagram of an apparatus for model training provided in an embodiment of the present disclosure. Referring to FIG. 4, the apparatus for model training 400 provided in the present embodiment includes an acquisition module 401, a channel pruning module 402, a knowledge distillation module 403, and an update module 404, wherein:
the acquisition module 401 is configured to execute step (a): acquiring a sample data set, a teacher model and an ith initial student model, which correspond to a target task, wherein the teacher model is a model trained for the target task;
the channel pruning module 402 is configured to execute step (b): performing an ith time of channel pruning on the ith initial student model, so as to acquire a student model which has been subjected to the ith time of channel pruning, wherein an initial value of i is 1;
the knowledge distillation module 403 is configured to execute step (c): according to the sample data set and the teacher model, performing an ith time of knowledge distillation on the student model which has been subjected to the ith time of channel pruning, so as to acquire an (i+1)th initial student model, wherein a compression ratio of the (i+1)th initial student model to a first initial student model is equal to a preset ith compression ratio; and
the update module 404 is configured to update i to be i+1, and return to instruct the channel pruning module 402 to execute the step (a) and instruct the channel pruning module 403 to execute the step (c), until the updated i is greater than a preset threshold value N, so as to acquire a target student model, wherein the target student model is an (N+1)th initial student model, and N is an integer greater than or equal to 1.

In some possible designs, when i=1, the ith initial student model and the teacher model are models with the same network structure.

In some possible designs, the preset ith compression ratio is jointly determined according to the scale of the target student model, the scale of the first initial student model, and the preset threshold value N.

In some possible designs, the preset ith compression ratio is jointly determined according to the scale of the target student model, the scale of the first initial student model and the preset threshold value N includes: determining a target compression ratio according to the scale of the target student model and the scale of the first initial student model; determining a target compression sub-ratio according to the target compression ratio and the preset threshold value N; and using an ith multiple of the target compression sub-ratio as the preset ith compression ratio.

In some possible designs, the channel pruning module 402 is specifically configured to: acquire importance factors of channels in a target layer of the ith initial student model; and sequentially delete M channels in the target layer according to the sequence of the importance factors from low to high, so as to acquire the student model which has been subjected to the ith time of channel pruning, wherein M is a positive integer greater than or equal to 1, and M is less than the total number of channels of the ith initial student model.

In some possible designs, the knowledge distillation module 403 is specifically configured to: respectively input sample data in the sample data set into the teacher model and the student model which has been subjected to the ith time of channel pruning, so as to acquire a first result output by the teacher model and a second result output by the student model which has been subjected to the ith time of channel pruning; acquire first loss information according to the first result output by the teacher model, the second result output by the student model which has been subjected to the ith time of channel pruning, and a truth value annotation of the sample data; and according to the first loss information, adjust a weight coefficient of a target parameter in the student model which has been subjected to the ith time of channel pruning, so as to acquire the (i+1)th initial student model.

In some possible designs, the knowledge distillation module 403 is specifically configured to: acquire second loss information according to the first result output by the teacher model and the second result output by the student model which has been subjected to the ith time of channel pruning; acquire third loss information according to the second result output by the student model which has been subjected to the ith time of channel pruning, and the truth value annotation of the sample data; and acquire the first loss information according to the second loss information and the third loss information.

The apparatus for model training provided in the present embodiment may be used for executing the technical solutions of any one of the foregoing method embodiments, and the implementation principles and technical effects thereof are similar, so reference may be made to the description of the foregoing embodiments, and details are not described herein again.

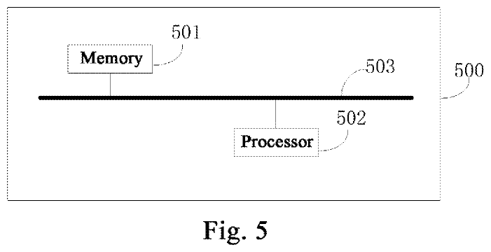

FIG. 5 is a schematic structural diagram of an electronic device provided in an embodiment of the present disclosure. Referring to FIG. 5, the electronic device 500 provided in the present embodiment includes a memory 501 and a processor 502.

The memory 501 may be an independent physical unit, and may be connected with the processor 502 through a bus 503. The memory 501 and the processor 502 may also be integrated together, implemented by hardware, or the like.

The memory 501 is used for storing a program instruction, and the processor 502 invokes the program instructions to execute the operations of any one of the foregoing method embodiments.

Optionally, when some or all of the methods in the foregoing embodiments are implemented by software, the electronic device 500 may only include that the processor 502. The memory 501 used for storing a program is located outside the electronic device 500, the processor 502 is connected with the memory via a circuit/wire for reading and executing the program stored in the memory.

The processor 502 may be a central processing unit (CPU), a network processor (NP), or a combination of the CPU and the NP.

The processor 502 may further include a hardware chip. The hardware chip may be an application-specific integrated circuit (ASIC), a programmable logic device (PLD), or a combination thereof. The PLD may be a complex programmable logic device (CPLD), a field-programmable gate array (FPGA), a generic array logic (GAL), or any combination thereof.

The memory 501 may include a volatile memory, such as a random-access memory (RAM); the memory may also include a non-volatile memory, such as a flash memory, a hard disk drive (HDD), or a solid-state drive (SSD); and the memory may further include a combination of the foregoing types of memories.

An embodiment of the present disclosure further provides a readable storage medium, wherein the readable storage medium includes a computer program, and when executed by at least one processor of an electronic device, the computer program implements the technical solutions of any one of the foregoing method embodiments.

An embodiment of the present disclosure further provides a program product, wherein the program product includes a computer program, the computer program is stored in a readable storage medium, at least one processor of the apparatus for model training may read the computer program from the readable storage medium, and the at least one processor executes the computer program, so that the apparatus for model training executes the technical solutions of any one of the foregoing method embodiments.

It should be noted that, in this paper, relational terms, such as “first” and “second”, are merely used for distinguishing one entity or operation from another entity or operation, and do not necessarily require or imply that any such actual relationship or order exists between these entities or operations. Moreover, the terms “include”, “contain” or any other variants thereof are intended to cover non-exclusive inclusions, such that a process, a method, an article or a device including a series of elements not only includes those elements, but also includes other elements that are not explicitly listed, or also includes elements inherent to such a process, method, article or device. If there are no more restrictions, the element defined by the sentence “including a . . . ” does not exclude the existence of other identical elements in the process, the method, the article or the device that includes the element.

The foregoing description is merely a specific embodiment of the present disclosure, so that those skilled in the art can understand or implement the present disclosure. Various modifications to these embodiments are apparent to those skilled in the art, and the general principles defined herein may be implemented in other embodiments without departing from the spirit or scope of the present disclosure. Therefore, the present disclosure will not be limited to these embodiments described herein, but is intended to conform to the widest scope consistent with the principles and novel features disclosed herein.

1. A method for model training, comprising:
step (a): acquiring a sample data set, a teacher model and an ith initial student model, which correspond to a target task, wherein the teacher model is a model trained for the target task;
step (b): performing an ith time of channel pruning on the ith initial student model, to acquire the student model which has been subjected to the ith time of channel pruning, wherein an initial value of i is 1;
step (c): according to the sample data set and the teacher mode, performing an ith time of knowledge distillation training on the student model which has been subjected to the ith time of channel pruning, to acquire an (i+1)th initial student model, wherein a compression ratio of the (i+1)th initial student model to a first initial student model is equal to a preset ith compression ratio; and
updating i to be i+1, and returning to the step (a) to the step (c) until the updated i is greater than a preset threshold value N, to acquire a target student model, wherein the target student model is an (N+1)th initial student model, and N is an integer greater than or equal to 1.

2. The method according to claim 1, wherein when i=1, the ith initial student model and the teacher model are models with the same network structure.

3. The method according to claim 1, wherein the preset ith compression ratio is jointly determined according to the scale of the target student model, the scale of the first initial student model, and the preset threshold value N.

4. The method according to claim 3, wherein the preset ith compression ratio is jointly determined according to the scale of the target student model, the scale of the first initial student model and the preset threshold value N, and the determining comprises:
determining a target compression ratio according to the scale of the target student model and the scale of the first initial student model;
determining a target compression sub-ratio according to the target compression ratio and the preset threshold value N; and
using an ith multiple of the target compression sub-ratio as the preset ith compression ratio.

5. The method according to claim 1, wherein performing the ith time of channel pruning on the ith initial student model, to acquire the student model which has been subjected to the ith time of channel pruning, comprises:
acquiring importance factors of channels in a target layer of the ith initial student model; and
sequentially deleting M channels in the target layer according to the sequence of the importance factors from low to high, to acquire the student model which has been subjected to the ith time of channel pruning, wherein M is a positive integer greater than or equal to 1, and M is less than the total number of channels of the ith initial student model.

6. The method according to claim 1, wherein according to the sample data set and the teacher mode, performing knowledge distillation training on the student model which has been subjected to the ith time of channel pruning, to acquire the (i+1)th initial student model, comprises:
respectively inputting sample data in the sample data set into the teacher model and the student model which has been subjected to the ith time of channel pruning, to acquire a first result output by the teacher model and a second result output by the student model which has been subjected to the ith time of channel pruning;
acquiring first loss information according to the first result output by the teacher model, the second result output by the student model which has been subjected to the ith time of channel pruning, and a truth value annotation of the sample data; and
according to the first loss information, adjusting a weight coefficient of a target parameter in the student model which has been subjected to the ith time of channel pruning, to acquire the (i+1)th initial student model.

7. The method according to claim 6, wherein acquiring the first loss information according to the first result output by the teacher model, the second result output by the student model which has been subjected to the ith time of channel pruning, and the truth value annotation of the sample data, comprises:
acquiring second loss information according to the first result output by the teacher model and the second result output by the student model which has been subjected to the ith time of channel pruning;
acquiring third loss information according to the second result output by the student model which has been subjected to the ith time of channel pruning and the truth value annotation of the sample data; and
acquiring the first loss information according to the second loss information and the third loss information.

8. (canceled)

9. An electronic device, comprising: a memory, a processor and a computer program instruction;
the memory is configured to store the computer program instruction; and
the processor is configured to execute the computer program instruction, to cause the electronic device to perform acts comprising:
step (a): acquiring a sample data set, a teacher model and an ith initial student model, which correspond to a target task, wherein the teacher model is a model trained for the target task;
step (b): performing an ith time of channel pruning on the ith initial student model, to acquire the student model which has been subjected to the ith time of channel pruning, wherein an initial value of i is 1;
step (c): according to the sample data set and the teacher mode, performing an ith time of knowledge distillation training on the student model which has been subjected to the ith time of channel pruning, to acquire an (i+1)th initial student model, wherein a compression ratio of the (i+1)th initial student model to a first initial student model is equal to a preset ith compression ratio; and
updating i to be i+1, and returning to the step (a) to the step (c) until the updated i is greater than a preset threshold value N, to acquire a target student model, wherein the target student model is an (N+1)th initial student model, and N is an integer greater than or equal to 1.

10. A non-transitory readable storage medium, comprising: a program, wherein,
when executed by a processor of an electronic device, the program causes the electronic device to perform acts comprising:
step (a): acquiring a sample data set, a teacher model and an ith initial student model, which correspond to a target task, wherein the teacher model is a model trained for the target task;
step (b): performing an ith time of channel pruning on the ith initial student model, to acquire a student model which has been subjected to the ith time of channel pruning, wherein an initial value of i is 1;
step (c): according to the sample data set and the teacher mode, performing an ith time of knowledge distillation training on the student model which has been subjected to the ith time of channel pruning, to acquire an (i+1)th initial student model, wherein a compression ratio of the (i+1)th initial student model to a first initial student model is equal to a preset ith compression ratio; and
updating i to be i+1, and returning to the step (a) to the step (c) until the updated i is greater than a preset threshold value N, to acquire a target student model, wherein the target student model is an (N+1)th initial student model, and N is an integer greater than or equal to 1.

11. The electronic device according to claim 9, wherein when i=1, the ith initial student model and the teacher model are models with the same network structure.

12. The electronic device according to claim 9, wherein the preset ith compression ratio is jointly determined according to the scale of the target student model, the scale of the first initial student model, and the preset threshold value N.

13. The electronic device according to claim 12, wherein the preset ith compression ratio is jointly determined according to the scale of the target student model, the scale of the first initial student model and the preset threshold value N, and the determining comprises:
determining a target compression ratio according to the scale of the target student model and the scale of the first initial student model;
determining a target compression sub-ratio according to the target compression ratio and the preset threshold value N; and
using an ith multiple of the target compression sub-ratio as the preset ith compression ratio.

14. The electronic device according to claim 9, wherein performing the ith time of channel pruning on the ith initial student model, to acquire the student model which has been subjected to the ith time of channel pruning, comprises:
acquiring importance factors of channels in a target layer of the ith initial student model; and
sequentially deleting M channels in the target layer according to the sequence of the importance factors from low to high, to acquire the student model which has been subjected to the ith time of channel pruning, wherein M is a positive integer greater than or equal to 1, and M is less than the total number of channels of the ith initial student model.

15. The electronic device according to claim 9, wherein according to the sample data set and the teacher mode, performing knowledge distillation training on the student model which has been subjected to the ith time of channel pruning, to acquire the (i+1)th initial student model, comprises:
respectively inputting sample data in the sample data set into the teacher model and the student model which has been subjected to the ith time of channel pruning, to acquire a first result output by the teacher model and a second result output by the student model which has been subjected to the ith time of channel pruning;
acquiring first loss information according to the first result output by the teacher model, the second result output by the student model which has been subjected to the ith time of channel pruning, and a truth value annotation of the sample data; and
according to the first loss information, adjusting a weight coefficient of a target parameter in the student model which has been subjected to the ith time of channel pruning, to acquire the (i+1)th initial student model.

16. The electronic device according to claim 15, wherein acquiring the first loss information according to the first result output by the teacher model, the second result output by the student model which has been subjected to the ith time of channel pruning, and the truth value annotation of the sample data, comprises:
acquiring second loss information according to the first result output by the teacher model and the second result output by the student model which has been subjected to the ith time of channel pruning;
acquiring third loss information according to the second result output by the student model which has been subjected to the ith time of channel pruning and the truth value annotation of the sample data; and
acquiring the first loss information according to the second loss information and the third loss information.

17. The non-transitory readable storage medium according to claim 10, wherein the preset ith compression ratio is jointly determined according to the scale of the target student model, the scale of the first initial student model, and the preset threshold value N.

18. The non-transitory readable storage medium according to claim 17, wherein the preset ith compression ratio is jointly determined according to the scale of the target student model, the scale of the first initial student model and the preset threshold value N, and the determining comprises:
determining a target compression ratio according to the scale of the target student model and the scale of the first initial student model;
determining a target compression sub-ratio according to the target compression ratio and the preset threshold value N; and
using an ith multiple of the target compression sub-ratio as the preset ith compression ratio.

19. The non-transitory readable storage medium according to claim 10, wherein performing the ith time of channel pruning on the ith initial student model, to acquire the student model which has been subjected to the ith time of channel pruning, comprises:
acquiring importance factors of channels in a target layer of the ith initial student model; and
sequentially deleting M channels in the target layer according to the sequence of the importance factors from low to high, to acquire the student model which has been subjected to the ith time of channel pruning, wherein M is a positive integer greater than or equal to 1, and M is less than the total number of channels of the ith initial student model.

20. The non-transitory readable storage medium according to claim 10, wherein according to the sample data set and the teacher mode, performing knowledge distillation training on the student model which has been subjected to the ith time of channel pruning, to acquire the (i+1)th initial student model, comprises:
respectively inputting sample data in the sample data set into the teacher model and the student model which has been subjected to the ith time of channel pruning, to acquire a first result output by the teacher model and a second result output by the student model which has been subjected to the ith time of channel pruning;
acquiring first loss information according to the first result output by the teacher model, the second result output by the student model which has been subjected to the ith time of channel pruning, and a truth value annotation of the sample data; and
according to the first loss information, adjusting a weight coefficient of a target parameter in the student model which has been subjected to the ith time of channel pruning, to acquire the (i+1)th initial student model.

21. The non-transitory readable storage medium according to claim 20, wherein acquiring the first loss information according to the first result output by the teacher model, the second result output by the student model which has been subjected to the ith time of channel pruning, and the truth value annotation of the sample data, comprises:
acquiring second loss information according to the first result output by the teacher model and the second result output by the student model which has been subjected to the ith time of channel pruning;
acquiring third loss information according to the second result output by the student model which has been subjected to the ith time of channel pruning and the truth value annotation of the sample data; and
acquiring the first loss information according to the second loss information and the third loss information.
